(19) United States
(12) Patent Application Publication
(10) Pub. No.: US 2007/0196051 A1
(43) Pub. Date: Aug. 23, 2007

(54) Substrate for forming passive elements in chip type

(75) Inventors: Shiow-Chang Luh, Fongshan City (TW); Chun-Hsiung Kuo, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: WALSIN TECHNOLOGY CORP., Taipei (TW)

(21) Appl. No.: 11/639,797

(22) Filed: Dec. 15, 2006

(30) Foreign Application Priority Data
Feb. 22, 2006 (TW) 095202978

(51) Int. Cl. G02B 6/30

(52) U.S. Cl. 385/49; 338/260

(57) ABSTRACT

A substrate for forming passive elements in chip type has a top surface, a thickness, multiple parallel grooves, multiple through holes and multiple chip regions. The parallel grooves are formed on the top surface of the substrate. The through holes are formed between and across two adjacent parallel grooves, and each through hole is separated from other through holes and has smooth inner walls. The chip regions are defined between adjacent through holes and parallel grooves and are arranged in a matrix.

### BACKGROUND OF THE INVENTION

1. Field of the Invention

The present invention relates to a substrate, and more particularly to a substrate for forming passive elements in chip type.

2. Description of Related Art

Because electronic products are becoming smaller, individual active and passive electronic elements have to become smaller, too. For example, standard chip resistors may be 0.60 mm in length, 0.30 mm in width and 0.23 mm in depth or 0.40 mm in length, 0.20 mm in width and 0.23 mm in depth. Smaller elements have smaller tolerances for error.

With reference to FIG. 2, a conventional manufacturing method comprises steps of etching grooves (31, 32) on a substrate (30), defining chip regions (33), forming main electrodes (34), forming resistor layers (35), forming inner protective layers (36), adjusting resistance, forming outer protective layers (37), dividing the substrate (30) into multiple strips (30′), forming inner electrodes (38), cutting the strips (30′) into multiple chip resistor units (40) and plating outer electrodes (39).

The step of etching grooves (31, 32) on a substrate (30) comprises mechanically etching multiple parallel grooves (31) and multiple perpendicular grooves (32) on a substrate (30) with a blade.

The step of defining chip regions (33) comprises defining multiple chip regions (33) between adjacent parallel grooves (31) and perpendicular grooves (32).

The step of forming main electrodes (34) comprises printing and baking metal organic paste on the top and bottom surfaces of a substrate (30) to form a pair of main electrodes (34) in each chip region (33). For example, a chip resistor having size of 0.60 mm in length, 0.30 mm in width and 0.23 mm in depth requires each main electrode (34) to be at least 0.15 mm in length.

The step of forming resistor layers (35) comprises printing and baking resistor elements between the two main electrodes (34) in each chip region (33) to form multiple resistor layers (35).

The step of forming inner protective layers (36) comprises printing and baking resin on the resistor layers (35) to form multiple inner protective layers (36).

The step of adjusting resistance comprises carving the inner protective layers (36) and resistor layers (35) with a laser beam to adjust resistance of the resistor layers (35).

The step of forming outer protective layers (37) comprises forming multiple outer protective layers (37) on the inner protective layers (36).

The step of dividing the substrate (30) into multiple strips (30′) comprises cutting the substrate (30) along the perpendicular grooves (32) with a laser beam or a rotating blade to divide the substrate (30) into multiple strips (30′). Each strip (30′) has two cut edges opposite to each other.

The step of forming inner electrodes (38) comprises plating inner electrodes (38) respectively on the cut edges of each strip (30′) by vacuum sputtering. The inner electrodes (38) connect the main electrodes (34) respectively on the top and bottom surfaces of the substrate (30).

The step of cutting the strips (30′) into multiple chip resistor units (40) comprises cutting the strips (30′) along the parallel grooves (31) into multiple chip resistor units (40).

The step of plating outer electrodes (39) comprises plating outer electrodes (39) on the inner electrodes (38) by barrel plating. Therefore, multiple chip resistors (R) are finished after plating outer electrodes (39) on the chip resistor units (40).

However, the conventional method has the following shortcoming. With reference to FIG. 3, the inner electrodes (38) may have different thicknesses because the cut edges of each strip (30′) are not smooth when the substrate (30) is divided into multiple strips (30′). Therefore, conductivity of the inner electrodes (38) will vary and adversely influence yield due to inconsistent thickness of the inner electrodes (38).

To overcome the shortcomings, the present invention provides a method of manufacturing chip resistors to mitigate or obviate the aforementioned problems.

To overcome the shortcomings, the present invention provides a substrate for forming passive elements in chip type to mitigate or obviate the aforementioned problems.

### SUMMARY OF THE INVENTION

The main objective of the invention is to provide a substrate for forming passive elements in chip type.

A substrate in accordance with the present invention has a top surface, a thickness, multiple parallel grooves, multiple through holes and multiple chip regions. The parallel grooves are formed on the top surface of the substrate. The through holes are formed between and across two adjacent parallel grooves, and each through hole is separated from other through holes and has smooth inner walls. The chip regions are defined between adjacent through holes and parallel grooves and are arranged in a matrix.

Other objectives, advantages and novel features of the invention will become more apparent from the following detailed description when taken in conjunction with the accompanying drawings.

### BRIEF DESCRIPTION OF THE DRAWINGS

FIG. 1 is a top view of a first embodiment of a substrate in accordance with the present invention;

FIG. 2 is a flow chart of a conventional method of manufacturing chip resistors; and

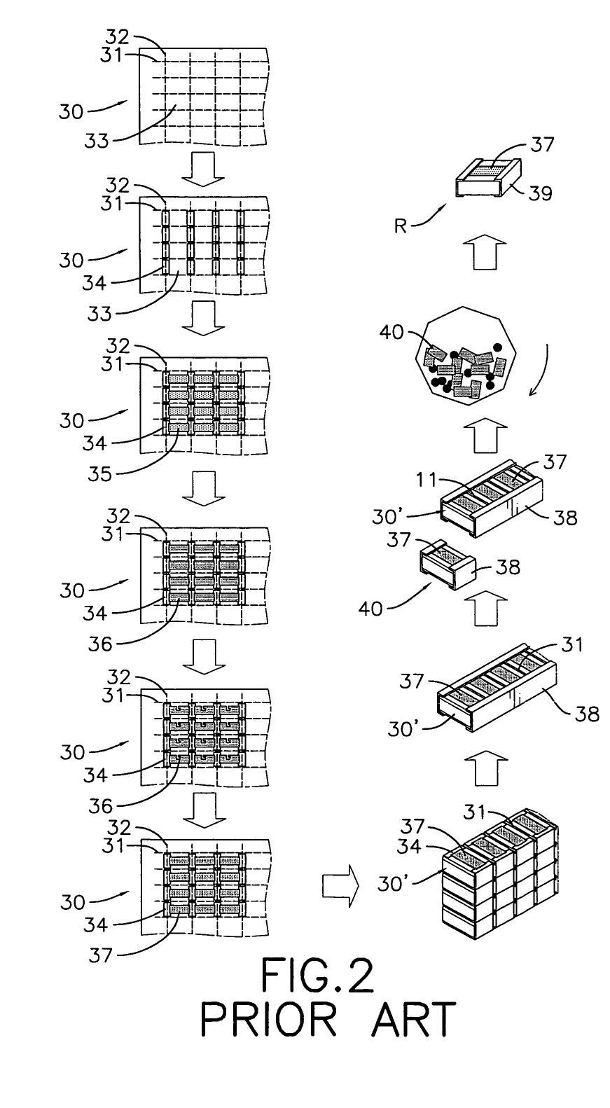

FIG. 3 is a side view in partial section of a chip resistor manufactured by the method in FIG. 3 without the inner and outer electrodes.

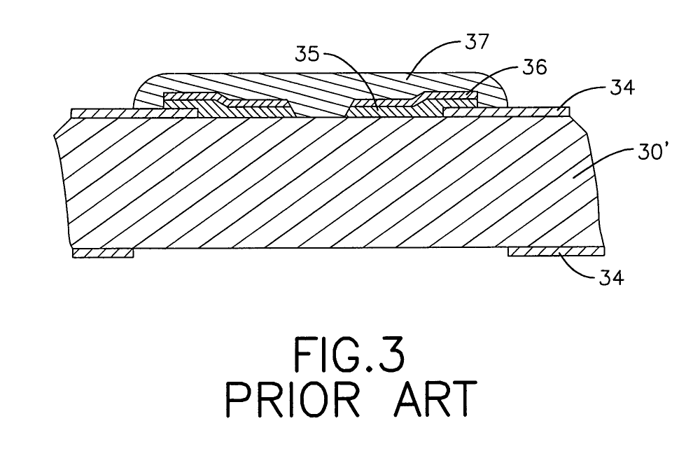

### DETAILED DESCRIPTION OF PREFERRED EMBODIMENT

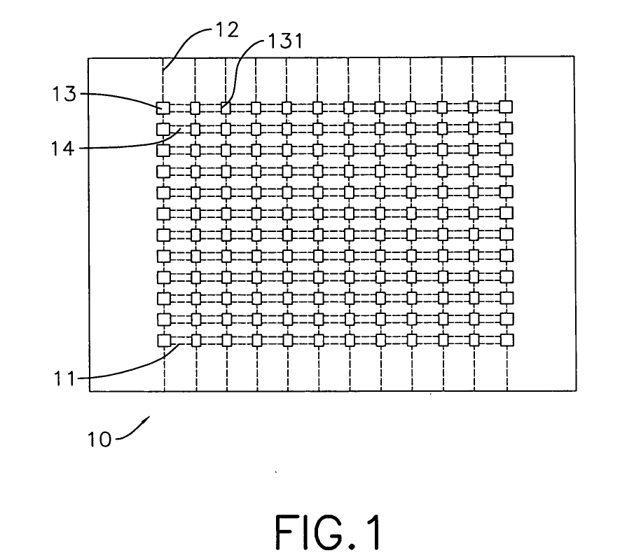

With reference to FIG. 1, a substrate (10) in accordance with the present invention may be made of cermet, can be used to manufacture chip resistors and has a top surface, a thickness, multiple parallel grooves (11), multiple optional perpendicular grooves (12), multiple through holes (13) and multiple chip regions (14).

The parallel grooves (11) are formed on the top surface of the substrate (10), may be formed by cutting the substrate (10) with a blade and respectively have a depth. The depth of each parallel groove (11) may not be deeper than half the thickness of the substrate (10).

The perpendicular grooves (12) are formed across the parallel grooves (11) on the top surface of the substrate (10), may be formed by cutting the substrate (10) with a blade and respectively have a depth. The depth of each perpendicular groove (11) may not be deeper than half the thickness of the substrate (10).

The through holes (13) are formed between and across two adjacent parallel grooves (11) and on one of the perpendicular grooves (12), and each through hole (13) is separated from other through holes (13) and has smooth inner walls (131).

Each chip region (14) is defined between adjacent through holes (13) and parallel grooves (11), and the chip regions (14) are arranged in a matrix.

Such a method has the following advantages.

1. The inner electrodes are flatly plated on the cut edges of each strip during the conventional method for manufacturing chip resistors because the inner walls (131) are smooth.

2. All chip regions (14) have the same size because each chip region (14) is defined between two through holes (13). Therefore, all passive elements in chip type are the same size.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A substrate for forming passive elements in chip type having:
a top surface;
a thickness;
multiple parallel grooves formed on the top surface of the substrate;
multiple through holes formed between and across two adjacent parallel grooves, and each through hole being separated from other through holes and having smooth inner walls; and
multiple chip regions defined between adjacent through holes and parallel grooves and being arranged in a matrix.

2. The substrate as claimed in claim 1 further having
multiple perpendicular grooves formed across the parallel grooves on the top surface of the substrate and respectively having a depth.

3. The substrate as claimed in claim 1, wherein each parallel groove has a depth being deeper than half the thickness of the substrate.

4. The substrate as claimed in claim 1, wherein the substrate is made of cermet.

5. The substrate as claimed in claim 2, wherein each perpendicular groove has a depth being deeper than half the thickness of the substrate.

6. The substrate as claimed in claim 2, wherein each parallel groove has a depth being deeper than half the thickness of the substrate.

7. The substrate as claimed in claim 2, wherein the substrate is made of cermet.

8. The substrate as claimed in claim 3, wherein the substrate is made of cermet.

9. The substrate as claimed in claim 3, wherein each perpendicular groove has a depth being deeper than half the thickness of the substrate.

10. The substrate as claimed in claim 4, wherein each perpendicular groove has a depth being deeper than half the thickness of the substrate.
